(19) United States
(12) Patent Application Publication
(10) Pub. No.: US 2010/0203867 A1
(43) Pub. Date: Aug. 12, 2010

(54) METHOD FOR INCREASING CALL REACHABILITY, AND ASSOCIATED APPARATUS

(76) Inventor: Chun-Ying Wu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/368,309

(22) Filed: Feb. 10, 2009

(51) Int. Cl. H04M 3/42

(52) U.S. Cl. 455/414.1

(57) ABSTRACT

A method for increasing call reachability includes: setting phone call establishment corresponding to a plurality of contact information entries at the same time; and when successfully making a phone call corresponding to a specific contact information entry is detected, selectively aborting one or more phone calls. An apparatus thereof includes: a control circuit arranged to control operations of the apparatus; and a program code. The control circuit executing the program code sets phone call establishment corresponding to a plurality of contact information entries at the same time, and selectively aborts one or more phone calls when successfully making a phone call corresponding to a specific contact information entry is detected.

### BACKGROUND

The present invention relates to making a phone call to a specific individual, and more particularly, to a method for increasing call reachability, and an associated apparatus.

As wireless communication technologies progress, and as mobile phones become smaller and more fashionable than those of years ago, most people tend to have more than one contact number, i.e. mobile phone number and one or more land line numbers corresponding to different locations. Some individuals may even have more than one mobile phone number. For example, a person has two mobile phones corresponding to different operators or different technologies, such as one that uses GSM (i.e. Global System for Mobile communications) and another that uses PHS (i.e. Personal Handyphone System). In another example, a person has two mobile phones, one is for outgoing phone calls only and the other is for incoming phone calls.

It is sometimes difficult to find somebody quickly in a situation where that person has many contact numbers, such as a mobile phone number, home, dormitory and laboratory extensions, office extension, etc. More particularly, it is unavoidable to make phone calls corresponding to all these contact numbers, starting from the most likely number an end user will answer until the end user picks up the call. Thus, a novel method is disclosed in the following to reduce the number of operations that a user needs to make phone calls corresponding to an end user's contact numbers.

### SUMMARY

It is therefore an objective of the claimed invention to provide a method for increasing call reachability, and to provide an associated apparatus, in order to solve the above-mentioned problem.

An exemplary embodiment of a method for increasing call reachability comprises: setting phone call establishment corresponding to a plurality of contact information entries at the same time; and when successfully making a phone call corresponding to a specific contact information entry of the contact information entries is detected, selectively aborting one or more phone calls.

An exemplary embodiment of an apparatus for increasing call reachability comprises: a control circuit arranged to control operations of the apparatus; and a program code embedded in the apparatus or received from outside the apparatus. The control circuit executing the program code tries to make phone calls corresponding to a plurality of contact information entries at the same time. In addition, when successfully making a phone call corresponding to a specific contact information entry of the contact information entries is detected, the control circuit executing the program code selectively aborts one or more phone calls.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for increasing call reachability according to a first embodiment of the present invention.

FIG. 2 is a flowchart of a method for increasing call reachability according to one embodiment of the present invention.

FIG. 3 illustrates an example of some implementation details of the method shown in FIG. 2 according to an embodiment of the present invention.

FIG. 4 illustrates another example of some implementation details of the method shown in FIG. 2 according to the embodiment shown in FIG. 3.

FIG. 5 through to FIG. 11 illustrate examples of a user interface provided by the apparatus shown in FIG. 1 and associated interactions according to a variation of the embodiment shown in FIG. 3.

FIG. 12 illustrates an example of a portion of a phone call control procedure of the method shown in FIG. 2 according to a variation of the embodiment shown in FIG. 3.

FIG. 13 illustrates an example of another portion of the phone call control procedure shown in FIG. 12.

FIG. 14 illustrates examples of a user interface provided by the apparatus shown in FIG. 1 according to a variation of the embodiment shown in FIG. 3.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

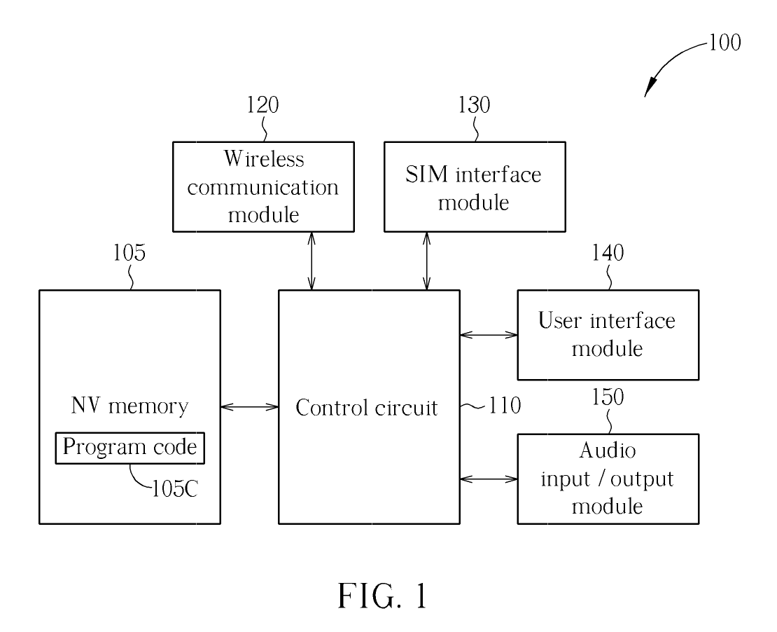

Please refer to FIG. 1, which illustrates a diagram of an apparatus 100 for increasing call reachability according to a first embodiment of the present invention. The apparatus 100 of this embodiment is a portable device equipped with multiple functionalities such as Personal Digital Assistant (PDA) and mobile phone functionalities. This is for illustrative purposes only, and is not meant to be a limitation of the present invention. According to a variation of this embodiment, the apparatus 100 can be a mobile phone. According to another variation of this embodiment, the apparatus 100 can be a PDA equipped with wireless communication capabilities.

As shown in FIG. 1, the apparatus 100 comprises a non-volatile (NV) memory 105, a control circuit 110, a wireless communication module 120, a Subscriber Identity Module (SIM) interface module 130, a user interface module 140, and an audio input/output module 150, where the NV memory 105 stores a program code 105C. For example, the control circuit 110 is a micro control unit (MCU), where the program code 105C is a firmware code and is received from outside the control circuit 110. In another example, the control circuit 110 is a micro processing unit (MPU), where the program code 105C is a software code and is received from outside the control circuit 110. This is for illustrative purposes only, and is not meant to be a limitation of the present invention. According to a variation of this embodiment, the control circuit 110 is a controller, where the program code 105C is a hardware code and is embedded within the control circuit 110. According to another variation of this embodiment, the control circuit 110 is an MPU, and the NV memory 105 is replaced with a storage module such as a hard disk drive (HDD), where the program code 105C is a software code stored in the HDD.

According to this embodiment, the control circuit 110 is arranged to control operations of the apparatus 100. More particularly, the control circuit 110 executing the program code 105C controls the operations of the apparatus 100. In addition, the wireless communication module 120 provides the apparatus 100 with a plurality of wireless communication capabilities. The wireless communication module 120 of this embodiment is capable of establishing two communication channels at the same time through two set of RF transceivers, such capability is typically called dual communication. This is for illustrative purposes only, and is not meant to be a limitation of the present invention. According to variations of this embodiment, the communication module 120 provides the apparatus 100 with 2^{nd} Generation (2G) wireless communication capability such as GSM, the so-called 2.5G wireless communication capability such as General Packet Radio Service (GPRS), 3^{rd} Generation (3G) wireless communication capability such as Wideband Code Division Multiple Access (WCDMA), the so-called 3.5G wireless communication capability such as High-Speed Packet Access (HSPA), and/or 4G wireless communication capability such as WIMAX.

In this embodiment, the SIM interface module 130 is arranged to access a plurality of SIMs storing respective service-subscriber keys such as respective International Mobile Subscriber Identities (IMSIs). Here SIM refers to both UICC card and SIM card. The control circuit 110 executing the program code 105C is capable of making a phone call by utilizing any of the SIMs. More particularly, the control circuit 110 executing the program code 105C is capable of making a phone call by utilizing any of the service-subscriber keys.

In addition, the user interface module 140 may connect to input devices such as a touch panel and a plurality of buttons. In practice, a liquid crystal display (LCD) of the touch panel is arranged to display information, and a user may read or view the information displayed by the LCD of the touch panel, and further control the apparatus 100 by using the touch panel and the buttons. Additionally, the audio input/output module 150 comprises audio processing and interfacing circuits, a microphone, and at least one speaker.

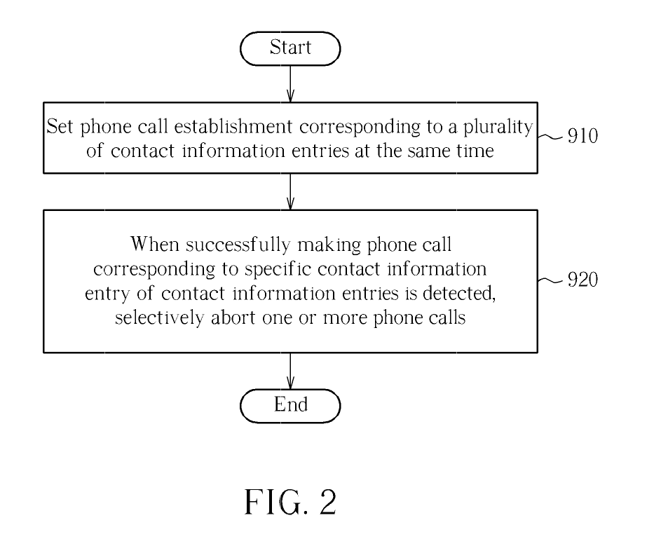

FIG. 2 is a flowchart of a method for increasing call reachability according to one embodiment of the present invention. The method shown in FIG. 2 can be applied to the apparatus 100, and more particularly, to the control circuit 110 executing the program code 105C. In addition, the method shown in FIG. 2 can be implemented by utilizing the apparatus 100, and more particularly, by utilizing the control circuit 110 executing the program code 105C. The method is described as follows.

In Step 910, the control circuit 110 executing the program code 105C sets phone call establishment corresponding to a plurality of contact information entries at the same time. That is, the control circuit 110 tries to make phone calls respectively corresponding to the contact information entries at the same time. In this embodiment, each of the contact information entries comprises at least one contact number. More particularly, the contact information entries comprise a plurality of contact numbers, and the control circuit 110 executing the program code 105C tries to make phone calls to the contact numbers at the same time.

In practice, the control circuit 110 executing the program code 105C tries to make phone calls to multiple contact numbers at the same time by selectively utilizing the respective service-subscriber keys stored in corresponding SIM cards. This is for illustrative purposes only, and is not meant to be a limitation of the present invention. According to a variation of this embodiment, the control circuit 110 executing the program code 105C determines whether a SIM card stores a plurality of service-subscriber keys such as a plurality of IMSIs. In this variation, when it is determined that the SIM card stores the plurality of service-subscriber keys (e.g. the IMSIs), the control circuit 110 executing the program code 105C tries to make phone calls to multiple contact numbers at the same time by selectively utilizing the service-subscriber keys stored in the SIM card.

In Step 920, when successfully making a phone call to a specific contact information entry of the contact information entries is detected, the control circuit 110 executing the program code 105C selectively aborts one or more phone calls. For example, when successfully making the phone call corresponding to the specific contact information entry of the contact information entries is detected, the control circuit 110 selectively aborts one or more phone calls except for the phone call corresponding to the specific contact information entry. More particularly, when it is detected that the phone call corresponding to the specific contact information entry is successfully made, the control circuit 110 executing the program code 105C selectively aborts all of the other phone call(s) (i.e. all the phone calls except for the phone call corresponding to the specific contact information entry).

In some embodiments, the control circuit 110 executing the program code 105C waits for a predetermined time period after successfully making the phone call to the specific contact information entry is detected. When the predetermined time period expires, the control circuit 110 executing the program code 105C aborts one or more phone calls except for the phone call corresponding to the specific contact information entry. For example, the predetermined time period can be a few seconds, or several seconds, or a few tens of seconds, depending on default settings or user settings allowed by the control circuit 110. This is for illustrative purposes only, and is not meant to be a limitation of the present invention. According to a variation of this embodiment, once successfully making the phone call to the specific contact information entry is detected, the control circuit 110 waits an user input to abort one or more phone calls except for the phone call corresponding to the specific contact information entry.

In this embodiment, during the predetermined time period, the control circuit 110 executing the program code 105C aborts a specific phone call of the phone calls when it is detected that a user determines to abort the specific phone call. For example, during the predetermined time period, the user presses one of the buttons or presses a virtual button provided by the touch panel mentioned above, in order to notify the control circuit 110 to abort a specific phone call. As a result, the control circuit 110 executing the program code 105C aborts the specific phone call immediately. The specific phone call may be any one of the phone calls. It may be the one not been picked up or the one been picked up. This is for illustrative purposes only, and is not meant to be a limitation of the present invention. According to a variation of this embodiment, during the predetermined time period, the user presses one of the buttons or presses a virtual button provided by the touch panel mentioned above, in order to notify the control circuit 110 to abort a plurality of specific phone calls of the phone calls, such as all the phone calls. As a result, the control circuit 110 executing the program code 105C immediately aborts the specific phone calls, such as all the phone calls.

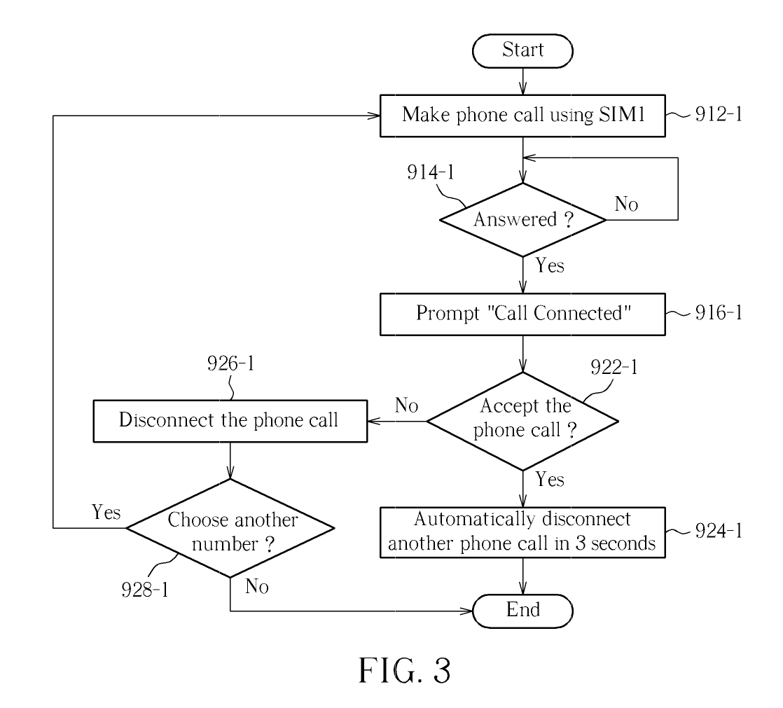

FIG. 3 illustrates an example of some implementation details of the method shown in FIG. 2 according to an embodiment of the present invention. In this embodiment, the plurality of SIM cards comprises a first SIM card SIMI and a second SIM card SIM2. In addition, Step 912-1, Step 914-1, and Step 916-1 correspond to Step 910 shown in FIG. 2, and Step 922-1, Step 924-1, Step 926-1, and Step 928-1 correspond to Step 920 shown in FIG. 2.

In Step 912-1, the control circuit 110 executing the program code 105C makes a phone call using SIMI (i.e. the first SIM of this embodiment).

In Step 914-1, the control circuit 110 executing the program code 105C determines whether the phone call is answered. If the phone call is answered, Step 916-1 is entered; otherwise, Step 914-1 is re-entered.

In Step 916-1, the control circuit 110 executing the program code 105C prompts “Call Connected”. In practice, the control circuit 110 executing the program code 105C utilizes the LCD of the touch panel mentioned above to display the message “Call Connected”.

In Step 922-1, the control circuit 110 executing the program code 105C determines whether the user accepts the phone call. For example, the control circuit 110 executing the program code 105C detects whether the user touches one of the buttons or a virtual button provided by the aforementioned touch panel, in order to determine whether the user accepts the phone call. If the phone call is accepted, Step 924-1 is entered; otherwise, Step 926-1 is entered.

In Step 924-1, the control circuit 110 executing the program code 105C can automatically disconnect another phone call in 3 seconds. For example, the control circuit 110 executing the program code 105C automatically disconnects a phone call that the control circuit 110 makes by using the second SIM card SIM2. After Step 924-1 is executed, the second SIM card SIM2 corresponds to an idle state, and the first SIM SIM1 corresponds to an in-call state.

In Step 926-1 the control circuit 110 executing the program code 105C disconnects the phone call that the control circuit 110 makes by using the first SIM card SIM1.

In Step 928-1, the control circuit 110 executing the program code 105C determines whether the user chooses another number (i.e. another contact information entry that differs from the specific contact information entry in this embodiment). If the user chooses another number, Step 912-1 is re-entered; otherwise, the working flow shown in FIG. 3 ends with the first SIM card SIM1 corresponding to an idle state.

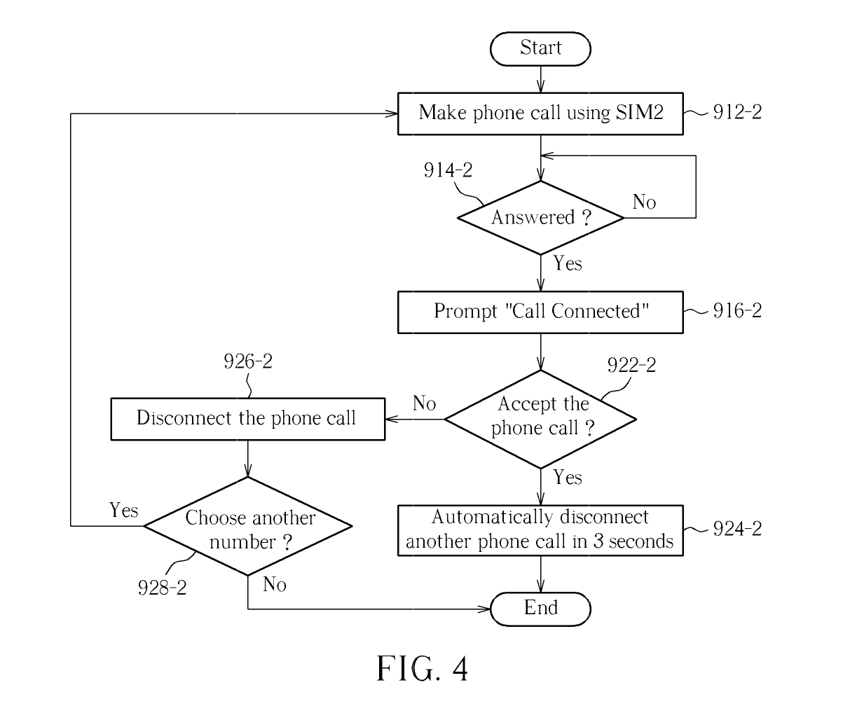

FIG. 4 illustrates another example of some implementation details of the method shown in FIG. 2 according to the embodiment shown in FIG. 3, where the working flow shown in FIG. 4 and the working flow shown in FIG. 3 can be executed in parallel. In this embodiment, Step 912-2, Step 914-2, and Step 916-2 correspond to Step 910 shown in FIG. 2, and Step 922-2, Step 924-2, Step 926-2, and Step 928-2 correspond to Step 920 shown in FIG. 2.

In Step 912-2, the control circuit 110 executing the program code 105C makes a phone call using SIM2 (i.e. the second SIM card of this embodiment).

In Step 914-2, the control circuit 110 executing the program code 105C determines whether the phone call is answered. If the phone call is answered, Step 916-2 is entered; otherwise, Step 914-2 is re-entered.

In Step 916-2, the control circuit 110 executing the program code 105C prompts “Call Connected”. In practice, the control circuit 110 executing the program code 105C utilizes the LCD of the touch panel mentioned above to display the message “Call Connected”.

In Step 922-2, the control circuit 110 executing the program code 105C determines whether the user accepts the phone call. For example, the control circuit 110 executing the program code 105C detects whether the user touches one of the buttons or a virtual button provided by the aforementioned touch panel, in order to determine whether the user accepts the phone call. If the phone call is accepted, Step 924-2 is entered; otherwise, Step 926-2 is entered.

In Step 924-2, the control circuit 110 executing the program code 105C can automatically disconnect another phone call in 3 seconds. For example, the control circuit 1110 executing the program code 105C automatically disconnects a phone call that the control circuit 110 makes by using the first SIM card SIM1. After Step 924-2 is executed, the first SIM card SIM1 corresponds to an idle state, and the second SIM SIM2 corresponds to an in-call state.

In Step 926-2 the control circuit 110 executing the program code 105C disconnects the phone call that the control circuit 110 makes by using the second SIM card SIM2.

In Step 928-2, the control circuit 110 executing the program code 105C determines whether the user chooses another number (i.e. another contact information entry that differs from the specific contact information entry in this embodiment). If the user chooses another number, Step 912-2 is re-entered; otherwise, the working flow shown in FIG. 4 ends with the second SIM card SIM2 corresponding to an idle state.

According to a variation of the embodiment shown in FIGS. 3 and 4, in Step 922-1 or Step 922-2, unless the user touches one of the buttons or a virtual button provided by the aforementioned touch panel to inform the control circuit 110 of his/her determination of disconnecting the phone call, the control circuit 110 executing the program code 105C determines that the user accepts the phone call. As a result, the 3 seconds expiration detection in Step 924-1 or Step 924-2 is measured starting from the time point that the control circuit 110 executing the program code 105C prompts “Call Connected” in Step 916-1 or Step 916-2.

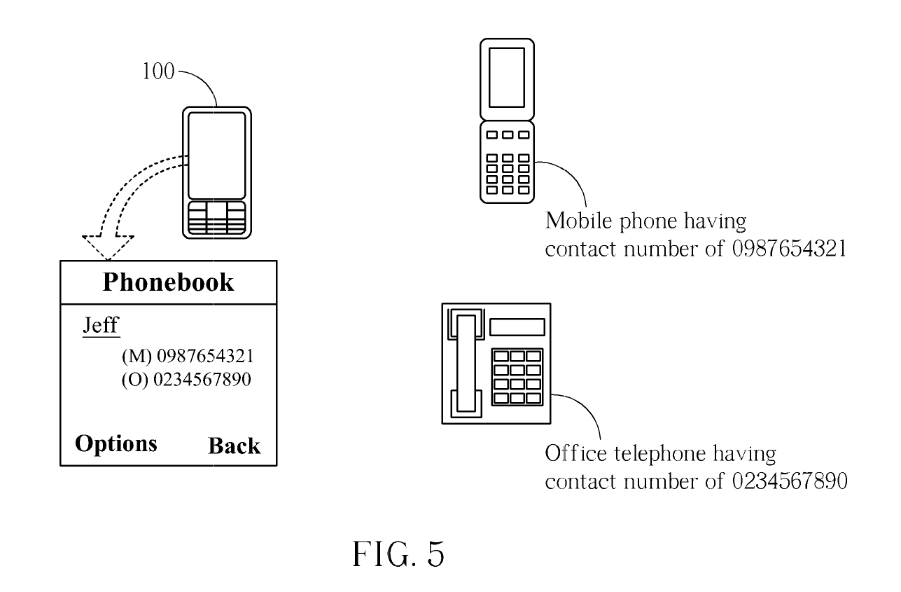

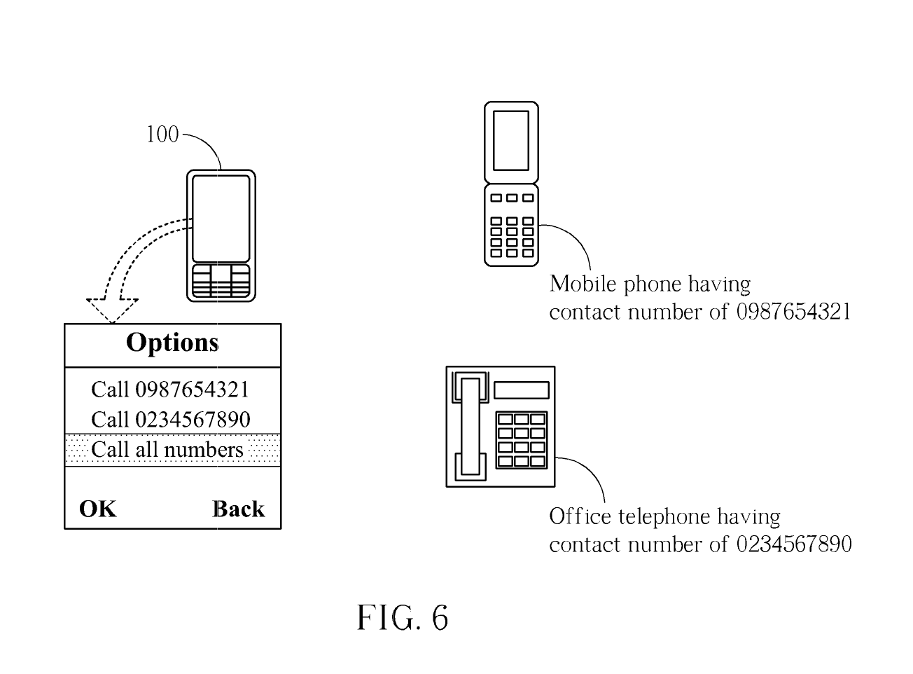

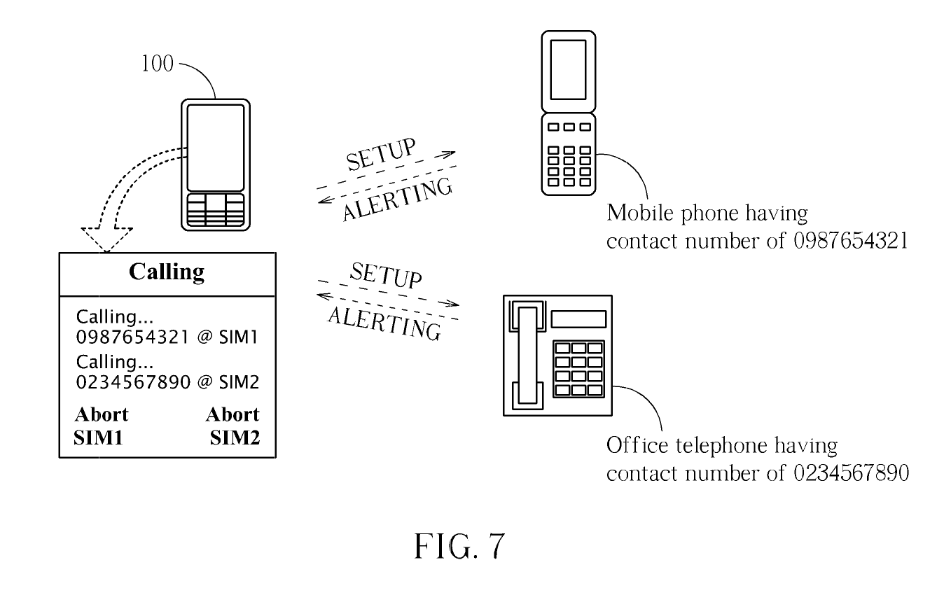

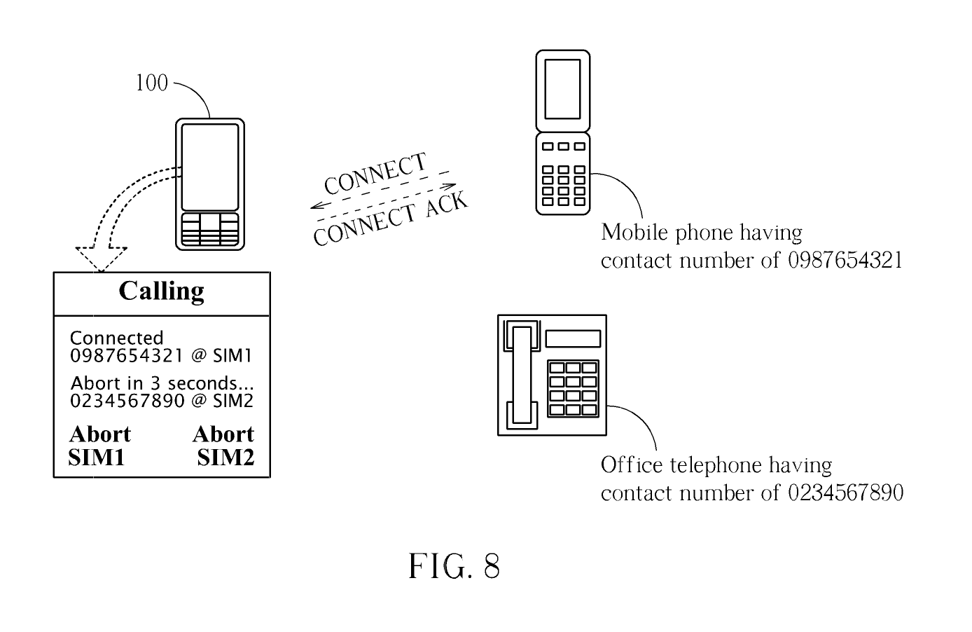

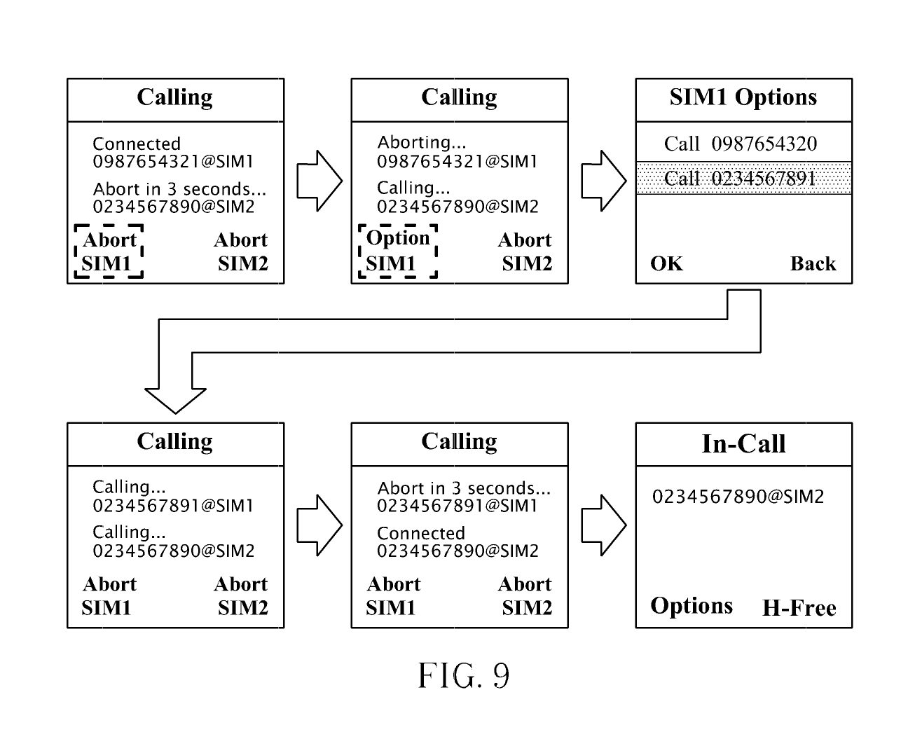

FIG. 5 through to FIG. 11 illustrate examples of a user interface provided by the apparatus 100 shown in FIG. 1 and associated interactions according to a variation of the embodiment shown in FIG. 3.

On the top of the user interface of an apparatus 100 shown in FIG. 5, a status representative “Phonebook” displayed on the LCD of the touch panel represents that the user selects an electronic phone book entry Jeff. More particularly, when the user accesses contact information entries of an individual such as a contact named “Jeff”, all contact information entries are displayed on the LCD. For example, the contact information entries of the individual “Jeff” comprise two contact numbers 0987654321 (labeled “(M) 0987654321”) and 0234567890 (labeled “(O) 0234567890”), which correspond to a mobile phone having the contact number of 0987654321 and an office telephone having the contact number of 0234567890, respectively. When the user presses a virtual button “Options” or a button that represents an “Options” menu regarding the contact information entries of the individual “Jeff” (e.g. a menu for listing options that the user may have in regard to the contact information entries of the individual “Jeff”), the user interface switches to another appearance, such as that shown in FIG. 6.

On the top of the user interface shown in FIG. 6, a status representative “Option” displayed on the LCD of the touch panel mentioned above represents that the user enters the “Options” menu regarding the contact information entries of the individual “Jeff”. For example, the options that the user may have in regard to the contact information entries of the individual “Jeff” comprise making a phone call corresponding to the contact number 0987654321 (labeled “Call 0987654321”), making a phone call corresponding to the contact number 0234567890 (labeled “Call 0234567890”), and making phone calls corresponding to all the contact numbers 0987654321 and 0234567890 at the same time (labeled “Call all numbers”). When the user selects the latter option “Call all numbers” and presses a virtual button “OK” or a button that represents a confirmation of making phone calls corresponding to the plurality of contact information entries of the individual “Jeff” at the same time, the user interface switches to another appearance, such as that shown in FIG. 7.

On the top of the user interface shown in FIG. 7, a status representative “Calling” displayed on the LCD of the touch panel mentioned above represents that the control circuit 110 executing the program code 105C is making two phone calls. More particularly, under the control of the control circuit 110 executing the program code 105C, detailed information such as making the phone call corresponding to the contact number 0987654321 by utilizing the first SIM card SIM1 (labeled “Calling . . . 0987654321@SIM1”) and making the phone call corresponding to the contact number 0234567890 by utilizing the second SIM card SIM2 (labeled “Calling . . . 0234567890@SIM2”) are listed below the status representative “Calling” to notify the user of the operations that the apparatus 100 is executing.

As shown in FIG. 7, some interactions between the apparatus 100 and the mobile phone, such as a setup operation (labeled “SETUP”) and an alerting operation (labeled “ALERTING”) in response to the setup operation, are illustrated between the apparatus 100 and the mobile phone. Similarly, some interactions between the apparatus 100 and the office telephone, such as a setup operation (labeled “SETUP”) and an alerting operation (labeled “ALERTING”) in response to the setup operation, are illustrated between the apparatus 100 and the office telephone.

Referring to FIG. 8, some interactions between the apparatus 100 and the mobile phone, such as a connection operation (labeled “CONNECT”) and a connection acknowledgement operation (labeled “CONNECT ACK”) in response to the connection operation, are illustrated between the apparatus 100 and the mobile phone. When somebody such as the contact “Jeff” answers the phone call corresponding to the contact number 0987654321, the connection operation (labeled “CONNECT”) is performed. While the connection acknowledgement operation (labeled “CONNECT ACK”) is performed, the user interface switches from the appearance shown in FIG. 7 to the appearance shown in FIG. 8.

More particularly, under the control of the control circuit 110 executing the program code 105C, detailed information such as successfully making the phone call corresponding to the contact number 0987654321 by utilizing the first SIM card SIM1 (labeled “Connected 0987654321@SIM1”) and aborting the phone call corresponding to the contact number 0234567890 in 3 seconds (labeled “Abort in 3 seconds . . . 0234567890@SIM2”) are listed below the status representative “Calling” to notify the user of the connection status of the phone call corresponding to the contact number 0987654321 and the expiration control of the phone call corresponding to the contact number 0234567890. If “Abort SIM1” is chosen by user determination, the phone call corresponding to the contact number 0234567890 will not be disconnected. Referring to FIG. 9 for the situation where “Abort SIM1” is chosen by user determination, when “Option SIM1” is further chosen by user determination, a list of contact information entries other than 0987654321 and 0234567890, if any (e.g. 0987654320 and 0234567891 as shown in the upper-right portion of FIG. 9), will be prompted to user for selection to be made via first SIM card SIM1. Please note that, in the situation where “Abort SIM1” is chosen by user determination, the phone call made by second SIM card SIM2 will not be disconnected after 3 seconds expiration, so the user can keep trying with the second SIM card SIM2.

Referring to FIG. 10 for the situation where “Abort SIM1” is not chosen by user determination, some interactions between the apparatus 100 and the office telephone, such as a disconnection operation (labeled “DISC”) and a release operation (labeled “RELEASE”) in response to the disconnection operation, are illustrated between the apparatus 100 and the office telephone. In this embodiment, during the disconnection operation (labeled “DISC”) and the release operation (labeled “RELEASE”), a portion of the detailed information, such as “Abort in 3 seconds . . . 0234567890@SIM2” shown in FIG. 8, is replaced with a revised version, such as “Aborting . . . 0234567890@SIM2” shown in FIG. 10, in order to notify the user of the status of currently aborting the phone call corresponding to the contact number 0234567890. After the release operation is completed, the user interface switches to another appearance, such as that shown in FIG. 11.

On the top of the user interface shown in FIG. 11, a status representative “In-Call” displayed on the LCD of the touch panel mentioned above represents that the control circuit 110 executing the program code 105C has aborted one or more phone calls except for the phone call corresponding to the specific contact information entry. In this embodiment, as the control circuit 110 executing the program code 105C has aborted the phone call corresponding to the contact number 0234567890, the detailed information of the phone call corresponding to the contact number 0234567890 (i.e. “Aborting . . . 0234567890@SIM2” shown in FIG. 10) is removed. Below the status representative “In-Call”, only “0987654321@SIM1” is listed to notify the user of the in-call status of the phone call corresponding to the contact number 0987654321.

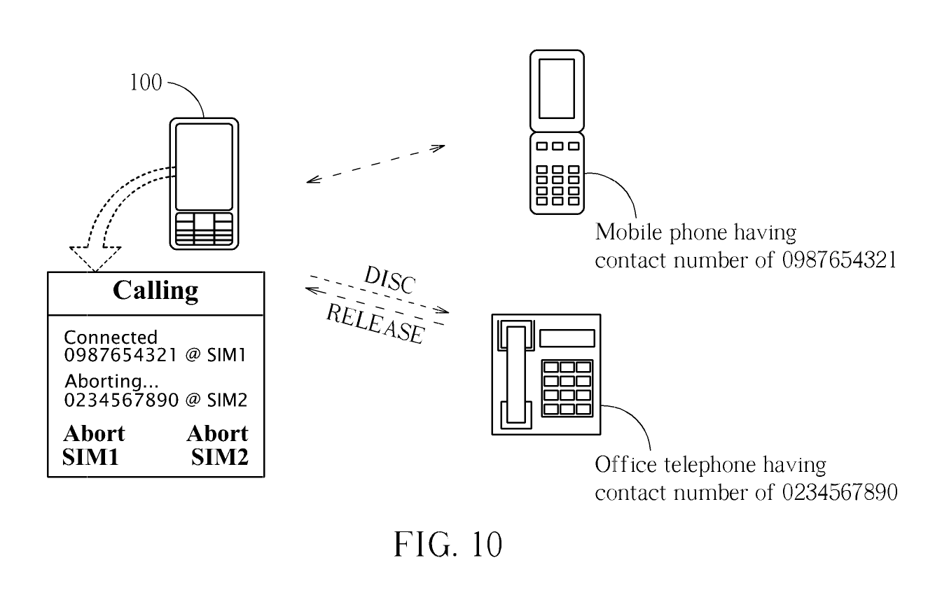

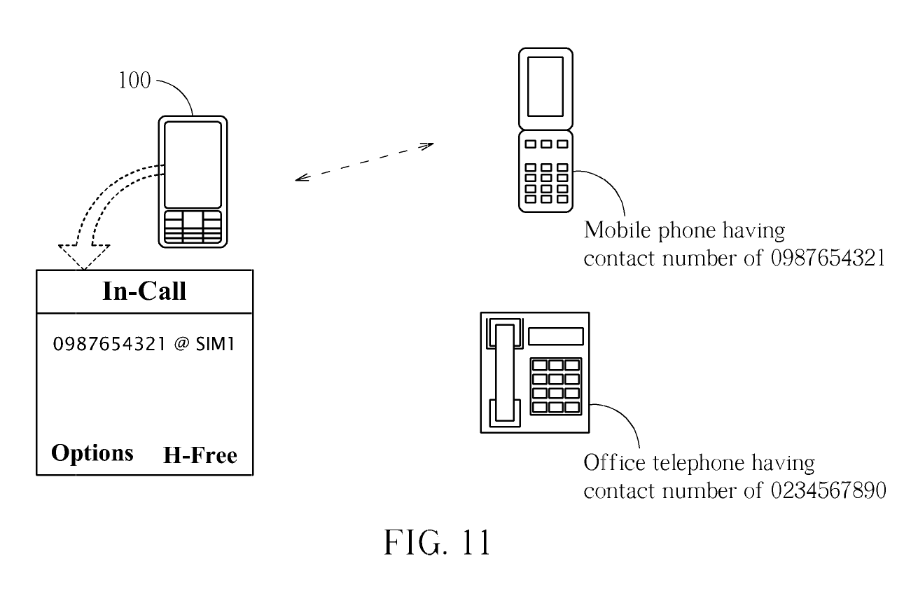

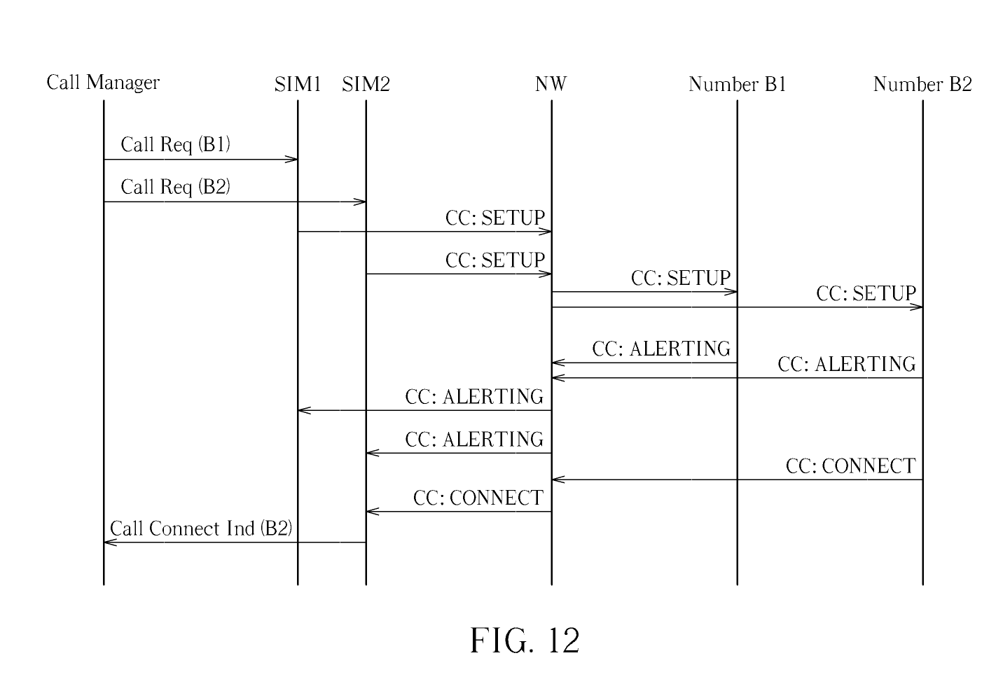

FIG. 12 illustrates an example of a portion of a phone call control procedure of the method shown in FIG. 2 according to a variation of the embodiment shown in FIG. 3. Each vertical line shown in FIG. 12 represents an object, to/from which an operation is performed. For example, an application program provided by at least a portion of the program code 105C is labeled “Call Manager”, the communication network accessed by the apparatus 100 is labeled “NW”, and a first telephone/mobile phone having a contact number of B1 and a second telephone/mobile phone having a contact number of B2 are respectively labeled “Number B1” and “Number B2”.

Please note that some interactions between the objects shown in FIG. 12, such as operations “CC: SETUP”, “CC: ALERTING”, and “CC: CONNECT”, are respectively equivalent to the operations “SETUP”, “ALERTING”, and “CONNECT” of the variation shown in FIG. 5 through to FIG. 11, where “CC:” in the operations “CC: SETUP”, “CC: ALERTING”, and “CC: CONNECT” stands for call control. In addition, operations “Call Req (B1)” and “Call Req (B2)” respectively represent a call request of the contact number of B1 and a call request of the contact number of B2. Additionally, an operation “Call Connect Ind (B2)” represents a call connection indicator of the contact number of B2. In this variation, the phone call corresponding to the contact number of B2 is answered.

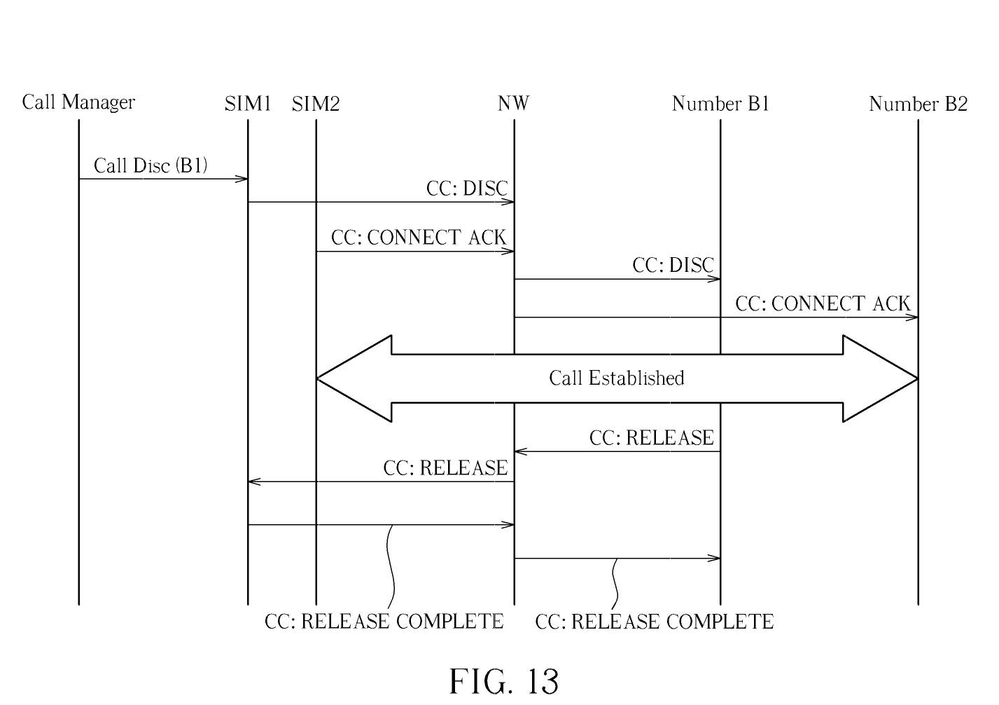

FIG. 13 illustrates an example of another portion of the phone call control procedure shown in FIG. 12. Similarly, some interactions between the objects shown in FIG. 13, such as operations “CC: DISC”, “CC: CONNECT ACK”, and “CC: RELEASE”, are respectively equivalent to the operations “DISC”, “CONNECT ACK”, and “RELEASE” of the variation shown in FIG. 5 through to FIG. 11, where “CC:” in the operations “CC: DISC”, “CC: CONNECT ACK”, and “CC: RELEASE” also stands for call control. In addition, an operation “CC: RELEASE COMPLETE” represents a completion response that is sent in response to the operation “CC: RELEASE”. Additionally, an operation “Call Disc (B1)” represents a call disconnection request of the contact number of B1. In this variation, as the phone call corresponding to the contact number of B2 is answered, the control circuit 110 executing the program code 105C determines to disconnect the phone call corresponding to the contact number of B1.

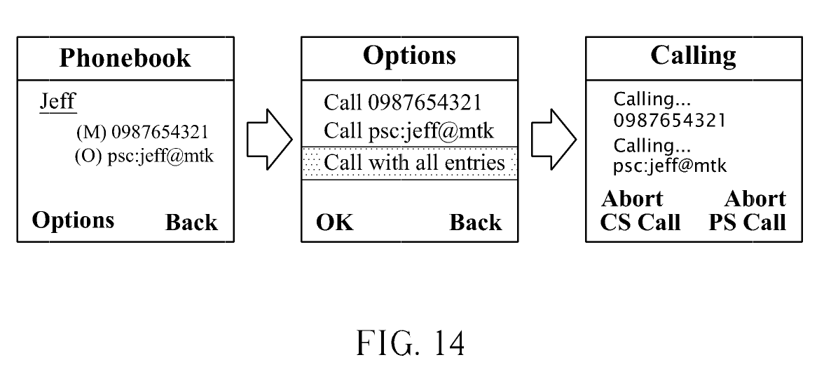

FIG. 14 illustrates examples of a user interface provided by the apparatus 100 shown in FIG. 1 according to a variation of the embodiment shown in FIG. 3. Compared to the variation shown in FIG. 5 through to FIG. 11, the aforementioned contact information entries of the variation shown in FIG. 14 comprise at least one contact number such as the contact number 0987654321, and further comprise at least one packet-switched call account such as a packet-switched call account “psc:jeff@mtk” (labeled “(O) psc:jeff@mtk”), where “psc:” in the packet-switched call account “psc:jeff@mtk” stands for packet-switched call, and “(O)” represents a replacement for the office telephone. A packet-switched call is a call made through packet-switched network. According to this variation, in Step 920, the control circuit 110 executing the program code 105C tries to make at least one phone call corresponding to the contact number 0987654321 and at least one phone call corresponding to the packet-switched call account “psc:jeff@mtk” at the same time.

Referring to the leftmost appearance of the user interface shown in FIG. 14, when the user presses a virtual button “Options” or a button that represents an “Options” menu regarding the contact information entries of the individual “Jeff” (e.g. a menu for listing options that the user may have in regard to the contact information entries of the individual “Jeff”), the user interface switches to another appearance, such as the central appearance of the user interface shown in FIG. 14.

For example, the options that the user may have in regard to the contact information entries of the individual “Jeff” comprise making a phone call corresponding to the contact number 0987654321 (labeled “Call 0987654321”), making a phone call corresponding to the packet-switched call account “psc:jeff@mtk” (labeled “(O) psc:jeff@mtk”), and making phone calls corresponding to all the contact information entries such as the contact numbers 0987654321 and the packet-switched call account “psc:jeff@mtk” at the same time (labeled “Call with all entries”). When the user selects the latter option “Call with all entries” and presses a virtual button “OK” or a button that represents a confirmation of making phone calls corresponding to the plurality of contact information entries of the individual “Jeff” at the same time, the user interface switches to another appearance, such as the rightmost appearance of the user interface shown in FIG. 14.

Under the control of the control circuit 110 executing the program code 105C, detailed information such as making the phone call corresponding to the contact number 0987654321 by utilizing circuit switching (CS) (labeled “Calling . . . 0987654321”) and making the phone call corresponding to the packet-switched call account “psc:jeff@mtk” by utilizing packet switching (PS) (labeled “Calling . . . psc:jeff@mtk”) are listed below the status representative “Calling” to notify the user of the operations that the apparatus 100 is executing.

Please note that a virtual button “Abort CS Call” represents aborting a circuit-switched call such as the phone call corresponding to the contact number 0987654321, while a virtual button “Abort PS Call” represents aborting a packet-switched call such as the phone call corresponding to the packet-switched call account “psc:jeff@mtk”. Similar descriptions for this variation are not repeated in detail here.

In contrast to the related art, in a situation where somebody has many contact numbers, such as those of mobile phones, home, dormitory and laboratory extensions, office and plant extensions, etc., the present invention method and apparatus can efficiently reduce the number of operations that a user performs to make phone calls corresponding to the contact numbers.

Those skilled in the art will readily observe that numerous modifications and alterations of the device and method may be made while retaining the teachings of the invention.

What is claimed is:

1. A method for increasing call reachability, comprising:
setting phone call establishment corresponding to a plurality of contact information entries at the same time; and
when successfully making a phone call corresponding to a specific contact information entry of the contact information entries is detected, selectively aborting one or more phone calls.

2. The method of claim 1, wherein the contact information entries comprise at least one contact number.

3. The method of claim 2, wherein the contact information entries comprise a plurality of contact numbers; and the step of setting phone call establishment corresponding to the plurality of contact information entries at the same time further comprises:
setting phone call establishment corresponding to the contact numbers at the same time.

4. The method of claim 3, wherein the step of setting phone call establishment corresponding to the plurality of contact numbers at the same time further comprises:
setting phone call establishment corresponding to the contact numbers at the same time by selectively utilizing respective service-subscriber keys stored in a plurality of Subscriber Identity Module (SIM) cards.

5. The method of claim 3, wherein the step of setting phone call establishment corresponding to the plurality of contact numbers at the same time further comprises:
determining whether a Subscriber Identity Module (SIM) card stores a plurality of service-subscriber keys; and
when it is determined that the SIM card stores the plurality of service-subscriber keys, setting phone call establishment corresponding to the contact numbers at the same time by selectively utilizing the service-subscriber keys stored in the SIM card.

6. The method of claim 2, wherein the contact information entries further comprise at least one packet-switched call account; and the step of setting phone call establishment corresponding to the plurality of contact information entries at the same time further comprises:
setting at least one phone call establishment corresponding to the contact number and at least one phone call corresponding to the packet-switched call account at the same time.

7. The method of claim 1, wherein the contact information entries comprise a plurality of packet-switched call accounts; and the step of setting phone call establishment corresponding to the plurality of contact information entries at the same time further comprises:
setting phone call establishment corresponding to the packet-switched call accounts at the same time.

8. The method of claim 1, wherein selectively aborting one or more phone calls further comprises:
waiting for a predetermined time period after successfully making the phone call corresponding to the specific contact information entry is detected; and
when the predetermined time period expires, aborting one or more phone calls except for the phone call corresponding to the specific contact information entry.

9. The method of claim 8, wherein selectively aborting one or more phone calls further comprises:
during the predetermined time period, aborting at least one specific phone call of the phone calls when it is detected that a user determines to abort the specific phone call.

10. The method of claim 1, wherein selectively aborting one or more phone calls further comprises:
as long as successfully making the phone call corresponding to the specific contact information entry is detected, aborting one or more phone calls except for the phone call corresponding to the specific contact information entry.

11. An apparatus for increasing call reachability, comprising:
a control circuit arranged to control operations of the apparatus; and
a program code embedded in the apparatus or received from outside the apparatus;
wherein the control circuit executing the program code sets phone call establishment corresponding to a plurality of contact information entries at the same time; and when successfully making a phone call corresponding to a specific contact information entry of the contact information entries is detected, the control circuit executing the program code selectively aborts one or more phone calls.

12. The apparatus of claim 11, wherein the contact information entries comprise at least one contact number.

13. The apparatus of claim 12, wherein the contact information entries comprise a plurality of contact numbers; and the control circuit executing the program code sets phone call establishment corresponding to the contact numbers at the same time.

14. The apparatus of claim 13, wherein the control circuit executing the program code sets phone call establishment corresponding to the contact numbers at the same time by selectively utilizing respective service-subscriber keys stored in a plurality of Subscriber Identity Module (SIM) cards.

15. The apparatus of claim 13, wherein the control circuit executing the program code determines whether a Subscriber Identity Module (SIM) card stores a plurality of service-subscriber keys; and when it is determined that the SIM card stores the plurality of service-subscriber keys, the control circuit executing the program code sets phone call establishment corresponding to the contact numbers at the same time by selectively utilizing the service-subscriber keys stored in the SIM card.

16. The apparatus of claim 12, wherein the contact information entries further comprise at least one packet-switched call account; and the control circuit executing the program code tries to make at least one phone call corresponding to the contact number and at least one phone call corresponding to the packet-switched call account at the same time.

17. The apparatus of claim 11, wherein the contact information entries comprise a plurality of packet-switched call accounts; and the control circuit executing the program code sets phone call establishment corresponding to the packet-switched call accounts at the same time.

18. The apparatus of claim 11, wherein the control circuit executing the program code waits for a predetermined time period after successfully making the phone call corresponding to the specific contact information entry is detected; and when the predetermined time period expires, the control circuit executing the program code aborts one or more phone calls except for the phone call corresponding to the specific contact information entry.

19. The apparatus of claim 18, wherein during the predetermined time period, the control circuit executing the program code aborts at least one specific phone call of the phone calls when it is detected that a user determines to abort the specific phone call.

20. The apparatus of claim 11, wherein as long as successfully making the phone call corresponding to the specific contact information entry is detected, the control circuit executing the program code aborts one or more phone calls except for the phone call corresponding to the specific contact information entry.
